(19) United States
(12) Patent Application Publication
(10) Pub. No.: US 2005/0129810 A1
(43) Pub. Date: Jun. 16, 2005

(54) Frozen confectionery product

(75) Inventors: Nigel Malcolm Lindner, Sharnbrook (GB); Jon Richard Oldroyd, Green Bay, WI (US); Andrew Sztehlo, Epping (AU); Deborah Jane Towell, Sharnbrook (GB)

Correspondence Address: UNILEVER INTELLECTUAL PROPERTY GROUP, 700 SYLVAN AVENUE,, BLDG C2 SOUTH, ENGLEWOOD CLIFFS, NJ, 07632-3100, US

(73) Assignee: Good Humor- Breyers Ice Cream Division of Conopco Inc

(21) Appl. No.: 10/732,775

(22) Filed: Dec. 10, 2003

(51) Int. Cl. A23G 1/00

(52) U.S. Cl. 426/100

(57) ABSTRACT

A frozen confectionery product is provided comprising a plurality of discrete water ice confections, each discrete water ice confection being able to contact directly other discrete water ice confections in the product, which water ice confections comprise an ice structuring protein (ISP), at least 6 wt % solids and have an average volume of less than 1 ml

### FIELD OF THE INVENTION

The present invention relates to frozen water ice confectionery products which comprise a plurality of individual confections and which contain ice structuring proteins.

### BACKGROUND TO THE INVENTION

The frozen confectionery industry is constantly seeking to devise novel products that will appeal to consumers. Whilst frozen confectionery products, such as ice cream and water ices tend to be sold either in containers, e.g. tubs of ice cream or cartridge dispensers, or as individually wrapped items such as ice lollies/popsicles, a relatively recent product innovation is in the form of single serve containers filled with a plurality of water ice beads. The beads are manufactured by a process which involves feeding uniformly sized drops of a liquid composition into a freezing chamber, typically filled with liquid nitrogen.

Water ices typically have from 25 to 35 wt % total solids, of which a large proportion is sugar. However, it has been found that if the solids content is above about 6 wt %, then the beads are too soft and tend to stick together and sinter, as well as deform. Unfortunately this means that it is difficult to add ingredients such as sugar that would produce the taste preferred by consumers since the amount of sugar needed raises the total amount of solids above the desired level. Accordingly, it has been necessary to use artificial sweeteners, which is less preferred by consumers, for reasons of taste as well as concerns about the use of artificial sweeteners.

### SUMMARY OF THE INVENTION

We have now found that the addition of ice structuring proteins to frozen water ice products reduces their tendency to stick and allows the production of free flowing frozen confectionery products that maintain their free-flowing characteristics for longer and at higher storage temperatures then existing products. The appearance of such products is significantly improved compared to existing products even after storage at temperatures above about −20° C. for several weeks.

Furthermore, it has been shown to be possible to increase the total solids content significantly above that for existing free-flowing products that lack ISPs without adversely affecting the free-flowing characteristics following storage. This has enabled the inclusion of effective amounts of sugar which in turn improves the taste and flavour of the product.

Accordingly, the present invention provides a frozen confectionery product comprising a plurality of discrete water ice confections, each discrete water ice confection being able to contact directly other discrete water ice confections in the product, which water ice confections comprise an ice structuring protein (ISP), at least 6 wt % solids and have an average volume of less than 1 ml.

Preferably the product comprises at least 10 discrete water ice confections, such as at least 20, 50 or 100 discrete water ice confections.

In a preferred embodiment the discrete water ice confections have an average volume of less than 0.5 ml. The frozen confections may, for example, be in the form of beads.

In a related aspect, the present invention provides a product comprising a container filled with a frozen confectionery product of the invention. Preferably the container has a volume of from 100 ml to 1000 ml.

The present invention also provides a retail unit comprising a plurality of containers, each container comprising a product of the invention wherein the product in each container is different.

### DETAILED DESCRIPTION OF THE INVENTION

Unless defined otherwise, all technical and scientific terms used herein have the same meaning as commonly understood by one of ordinary skill in the art (e.g. in frozen confectionery manufacture, molecular biology and biochemistry). Definitions and descriptions of various terms and techniques used in frozen confectionery manufacture are found in Ice Cream, 4^{th} Edition, Arbuckle (1986), Van Nostrand Reinhold Company, New York, N.Y. Standard techniques are used for molecular and biochemical methods (see generally, Sambrook et al., Molecular Cloning: A Laboratory Manual, 3^{rd} ed. (2001) Cold Spring Harbor Laboratory Press, Cold Spring Harbor, N.Y. and Ausubel et al., Short Protocols in Molecular Biology (1999) 4^{th} Ed, John Wiley & Sons, Inc.—and the full version entitled Current Protocols in Molecular Biology).

Ice Structuring Proteins

Ice structuring proteins (ISPs) are proteins that can influence the shape and size of the crystals of ice formed when freezing does occur, and inhibit recrystallisation of ice (Clarke et al., 2002, Cryoletters 23: 89-92). Many of these proteins were identified originally in organisms that live in sub-zero environments and are thought to protect the organism from the deleterious effects of the formation of ice crystals in the cells of the organism. For this reason many ice structuring proteins are also known as antifreeze proteins (AFPs). In the context of the present invention, an ISP is defined as a protein that has ice recrystallisation inhibitory (RI) activity.

Ice recrystallisation inhibitory activity properties can conveniently be measured by means of a modified splat assay as described in WO 00/53029.

2.5 μl of the solution under investigation in 30%; (w/w) sucrose is transferred onto a clean, appropriately labelled, 16 mm circular coverslip. A second coverslip is placed on top of the drop of solution and the sandwich pressed together between finger and thumb. The sandwich is dropped into a bath of hexane held at −80° C. in a box of dry ice. When all sandwiches have been prepared, sandwiches are transferred from the −80° C. hexane bath to the viewing chamber containing hexane held at −6° C. using forceps pre-cooled in the dry ice. Upon transfer to −6° C., sandwiches can be seen to change from a transparent to an opaque appearance. Images are recorded by video camera and grabbed into an image analysis system (LUCIA, Nikon) using a 20× objective. Images of each splat are recorded at time=0 and again after 60 minutes. The size of the ice-crystals in both assays is compared by placing the slides within a temperature controlled cryostat cabinet (Bright Instrument Co Ltd, Huntington, UK). Images of the samples are transfered to a Quantimet 520 MC image analysis system (Leica, Cambridge UK) by means of a Sony monochrome CCD videocamera.

Ice crystal sizing can be performed by hand-drawing around the ice-crystals. Typically, at least 100 to 400 crystals are sized for each sample. The ice crystal size is taken as being the longest dimension of the 2D projection of each crystal. The average crystal size is determined as the number average of the individual crystal sizes. The size of the ice-crystals in both assays is compared. If the size at 30-60 minutes is similar or only moderately (less than 10%) increased compared to the size at t=0, and/or the crystal size is less than 20 micrometer, preferably from 5 to 15 micrometer this is an indication of good ice-crystal recrystallisation properties.

Significant ice recrystallisation inhibitory activity can be defined as where a 0.01 wt % solution of the ISP in 30 wt % sucrose, cooled rapidly (at least Δ50° C. per minute) to −40° C., heated rapidly (at least Δ50° C. per minute) to −6° C. and then held at this temperature results in an increase in average ice crystal size over one hour of less than 5 μm.

Types of ISPs

ISPs for use according to the present invention can be derived from any source provided they are suitable for inclusion in food products. ISPs have been identified to date in fish, plants, lichen, fungi, micro-organisms and insects. In addition, a number of synthetic ISPs have been described.

Examples of fish ISP materials are AFGP (for example obtainable from Atlantic cod, Greenland cod and Tomcod), Type I ISP (for example obtainable from Winter flounder, Yellowtail flounder, Shorthorn sculpin and Grubby sculpin), Type II ISP (for example obtainable from Sea raven, Smelt and Atlantic herring) and Type III ISP (for example obtainable from Ocean pout, Atlantic wolffish, Radiated shanny, Rock gunnel and Laval's eelpout).

Type III ISPs are particularly preferred. Type III ISPs typically have a molecular weight of from about 6.5 to about 14 kDa, a beta sandwich secondary structure and a globular tertiary structure. A number of genes encoding type III ISPs have been cloned (Davies and Hew, 1990, FASEB J. 4: 2460-2468). A particularly preferred type III ISP is type III HPLC-12 (Accession No. P19614 in the Swiss-Prot protein database).

Lichen AFPs are described in WO99/37673 and WO01/83534.

Examples of plants in which ISPs have been obtained are described in WO 98/04699 and WO 98/4148 and include garlic-mustard, blue wood aster, spring oat, winter cress, winter canola, Brussels sprout, carrot (GenBank Accession No. CAB69453), Dutchman's breeches, spurge, daylily, winter barley, Virginia waterleaf, narrow-leaved plantain, plantain, speargrass, Kentucky bluegrass, Eastern cottonwood, white oak, winter rye (Sidebottom et al., 2000, Nature 406: 256), bittersweet nightshade, potato, chickweed, dandelion, spring and winter wheat, triticale, periwinkle, violet and grass.

The ISPs can be obtained by extraction from native sources by any suitable process, for example the isolation processes as described in WO 98/04699 and WO 98/4148.

Alternatively, ISPs can be obtained by the use of recombinant technology. For example host cells, typically micro-organisms or plant cells, may be modified to express ISPs and the ISPs may then be isolated and used in accordance with the present invention. Techniques for introducing nucleic acid constructs encoding ISPs into host cells are well known in the art.

Typically, an appropriate host cell or organism would be transformed by a nucleic acid construct that encodes the desired ISP. The nucleotide sequence coding for the polypeptide can be inserted into a suitable expression vector encoding the necessary elements for transcription and translation and in such a manner that they will be expressed under appropriate conditions (e.g. in proper orientation and correct reading frame and with appropriate targeting and expression sequences). The methods required to construct these expression vectors are well known to those skilled in the art.

A number of expression systems may be used to express the polypeptide coding sequence. These include, but are not limited to, bacteria, fungi (including yeast), insect cell systems, plant cell culture systems and plants all transformed with the appropriate expression vectors. Preferred hosts are those that are considered food grade—‘generally regarded as safe’ (GRAS).

Suitable fungal species include yeasts such as (but not limited to) those of the genera Saccharomyces, Kluyveromyces, Pichia, Hansenula, Candida, Schizo saccharomyces and the like, and filamentous species such as (but not limited to) those of the genera Aspergillus, Trichoderma, Mucor, Neurospora, Fusarium and the like. Preferably the species selected is a yeast, most preferably a species of Saccharomyces such as S. cerevisiae. Where glycosylation of the ISP leads to reduced activity then it is preferred that the host exhibits reduced glycosylation of heterologous proteins.

A wide variety of plants and plant cell systems can also be transformed with the nucleic acid constructs of the desired polypeptides. Suitable plant species include maize, tomato, tobacco, carrots, strawberries, rape seed and sugar beet.

The sequences encoding the ISPs are preferably at least 80% identical at the amino acid level to an ISP identified in nature, more preferably at least 95% or 100% identical. However, persons skilled in the art may make conservative substitutions or other amino acid changes that do not reduce the RI activity of the ISP. For the purpose of the invention these ISPs possessing this high level of identity to an ISP that naturally occurs are also embraced within the term “ISPs”.

Frozen Confectionery Products

Frozen confectionery products of the present invention comprise a plurality of discrete water ice confections. The water ice confections are not separated from one another by the use of wrappings or other non-edible packaging, or by compartmentalisation. Instead, the individual water ices are packaged such that they are able to contact directly other individual frozen confections. However, the individual water ices are able to move relative to each other, in other words they are not immobilised within, for example, a matrix such as a coating.

In a highly preferred embodiment, the water ice of the invention is free-flowing. Preferably, the frozen confectionery product of the invention remains free-flowing after storage at −10° C. for at least 10 days, more preferably at least 15 or 20 days.

The frozen confections are relatively small, for example having an average volume of less than 1 ml, more preferably less than 0.5 ml. By way of example, beads having a diameter of from 5 mm to 10 mm would have a volume of from about 0.065 ml to about 0.5 ml. Typically, the discrete frozen confections have a minimum average volume such that each confection can be readily distinguished by a consumer. For example, the discrete frozen confection preferably have a minimum average volume of at least about 0.02 ml.

The discrete frozen confections may be made to any shape, such as in the form of cubes or spheres. Preferably, the frozen confections are substantially spherical.

The frozen confections may be in the form of a composite product where at least one portion or region of the product, such as a core or layer, does not contain ISPs. An example of this would be a product containing a core of ice cream which lacks ISP, coated in a layer of water ice that does contain ISP. Preferably, substantially the outer layer of the composition confection comprises ISP, i.e. the region which will come into contact with other discrete frozen confections. It will be appreciated that in the case of a composite product, the wt % amount of ISP added is calculated solely in relation to those components of the confection that contain ISP and not in relation to the complete product.

Frozen confections may be aerated or unaerated. By unaerated is meant a frozen confection having an overrun of less then 20%, preferably less than 10%. An unaerated frozen confection is not subjected to deliberate steps such as whipping to increase the gas content. Nonetheless, it will be appreciated that during the preparation of unaerated frozen confections, low levels of gas, such as air, may be incorporated in the product.

Water ice confections typically contain sugar, water, colour, fruit acid or other acidifying agent, fruit or fruit flavouring and stabiliser. Preferably, the total solids content is at least 6 wt %, more preferably at least 8 wt % or at least 10, 12, 15 or 20 wt % and may be as high as about 35 wt %. Preferably the total solids content is less then 35 wt %, more preferably less than 25 wt %. Water ices may be aerated or unaerated. If aerated, the overrun is typically less than about 50%, for example from about 25% to 30%. In one embodiment, the water ice confections of the invention are unaerated.

Preferably the water ice confections contain less than 2 wt % artificial sweeteners, more preferably less than 1 wt %. In a highly preferred embodiment, no artificial sweeteners, such as aspartame or acesulfame are present in the water ice confections.

Frozen confections of the invention typically comprise one or more stabiliser, such as one or more stabilisers selected from gums, agar, alginates and derivatives thereof, gelatin, pectin, lecithin, sodium carboxymethylcellulose, carrageenan and furcelleran. Preferably a blend of stabilisers is used, such as blend of a gum and carrageenan. In a preferred embodiment, the frozen confection comprises from 0.1 to 1 wt % stabiliser.

Frozen confections of the invention typically comprise at least about 0.0005 wt % ISP. ISPs can be used at very low concentrations and therefore preferably the confections comprise less than 0.05 wt % ISP. A preferred range is from about 0.001 to 0.01 wt %.

Frozen confections of the invention can be manufactured using a number of techniques known in the art. For example, free-flowing beads can be manufactured by dispensing drops of the liquid mix into a freezing chamber of liquid nitrogen (see WO96/29896). Other shapes can be manufactured by moulding techniques, for example by introducing a liquid premix into a cooled mould. Moulded products may contain complex shapes and have a high degree of surface definition.

Ice cream-containing products and the like need not be subjected to a cold hardening step of below from −20° C. to −25° C., although this may be used if desired, especially if the product is a composite product with a layer or core that does not contain ISP.

The frozen confectionery product of the invention may be packaged in containers for sale to consumers as an individual unit. The volume of such containers is typically from 100 ml to 1000 ml, such as from 200 ml to 500 ml.

However, the product can also be packaged in larger containers for retail purposes where the product is dispensed into smaller containers at the retail premises, e.g. in fast food outlets or as a pick ‘n’ mix format where consumers can choose from frozen confections of the invention having different shapes, flavours and/or colours. These larger containers may, for example, have a volume greater than about 1000 ml, for example at least 2000 ml or 5000 ml.

The present invention will now be further described with reference to the following examples, which are illustrative only and non-limiting.

### EXAMPLES

### Examples 1 to 5 and Comparative Examples 1 to 4—Water Ice Beads

Materials and Methods

Water ice premixes were produced according to the following recipes.

TABLE 1

| Ingredients | C. Ex. 1 | Ex. 1a | Ex. 1b | Ex. 1c | Ex. 1d |
|---|---|---|---|---|---|
| Sugar source (I) | 15.0 | 15.0 | 15.0 | 15.0 | 15.0 |
| Stabiliser (II) | 0.35 | 0.35 | 0.35 | 0.35 | 0.35 |
| Colour (III) | 0.088 | 0.088 | 0.088 | 0.088 | 0.088 |
| Flavouring (IV) | 0.31 | 0.31 | 0.31 | 0.31 | 0.31 |
| Fat source (V) | 0.8 | 0.8 | 0.8 | 0.8 | 0.8 |
| Emulsifier (VI) | 0.2 | 0.2 | 0.2 | 0.2 | 0.2 |
| Fruit juice concentrate | 5.0 | 5.0 | 5.0 | 5.0 | 5.0 |
| (VII) | | | | | |
| Food acid (VIII) | 0.32 | 0.32 | 0.32 | 0.32 | 0.32 |
| Water | 77.929 | 78 | 78.4 | 78.98 | 79.4 |
| ISP (%) | 0 | 0.0005 | 0.0025 | 0.005 | 0.007 |
| Fat (%) | 1.0 | 1.0 | 1.0 | 1.0 | 1.0 |
| Total solids (%) | 20 | 20 | 20 | 20 | 20 |

| Ingredients | C. Ex. 2 | Ex. 2 | C. Ex. 3 | Ex. 3 |
|---|---|---|---|---|
| Sugar source (I) | 13.7 | 13.7 | 14.0 | 14.0 |
| Stabiliser (II) | 0.353 | 0.353 | 0.353 | 0.353 |
| Artificial sweetener (VIV) | 0 | 0 | 0 | 0 |
| Colour (III) | 0.088 | 0.088 | 0.088 | 0.088 |
| Flavouring (IV) | 0.31 | 0.31 | 0.31 | 0.31 |
| Fat source (V) | 0.8 | 0.8 | 0.8 | 0.8 |
| Emulsifier (VI) | 0.2 | 0.2 | 0.2 | 0.2 |
| Salt | 0 | 0 | 0 | 0 |
| Fruit juice concentrate (VII) | 5.0 | 5.0 | 5.0 | 5.0 |
| Food acid (VIII) | 0.32 | 0.32 | 0.32 | 0.32 |
| Water | 79.229 | 80.8 | 78.929 | 80.8 |
| ISP (%) | 0 | 0.005 | 0 | 0.005 |
| Fat (%) | 1.0 | 1.0 | 1.0 | 1.0 |
| Total solids (%) | 15 | 15 | 9 | 9 |

| Ingredients | C. Ex. 4 | Ex. 4 | Ex. 5 |
|---|---|---|---|
| Sugar source (I) | 4.21 | 4.21 | 15.5 |
| Stabiliser (II) | 0.35 | 0.35 | 0.35 |
| Artificial sweetener (VIV) | 0.036 | 0.036 | 0 |
| Colour (III) | 0.088 | 0.088 | 0.11 |
| Flavouring (IV) | 0.31 | 0.31 | 0.40 |
| Fat source (II) | 0.8 | 0.8 | 0.8 |
| Emulsifier (VI) | 0.2 | 0.2 | 0.2 |
| Salt | 0.09 | 0.09 | 0 |
| Fruit juice concentrate (VII) | 0 | 0 | 5.2 |
| Food acid (VIII) | 0.32 | 0.32 | 0.77 |
| Water | 93.59 | 93.59 | 75.6 |
| ISP (%) | 0 | 0.005 | 0.005 |
| Fat (%) | 1.0 | 1.0 | 1.0 |
| Total solids (%) | 6 | 6 | 20 |

I Sugar source can be any typically used water ice ingredient such as either sucrose or fructose or a blend of sucrose/fructose in 97/3 ratio or sucrose/fructose in 54/46 ratio.
II A blend of pectin/carrageenan.
III Any typically used water ice colour.
IV Any typically used water ice flavourings.
V Fat source such as coconut oil or other bland fat type.
VI Emulsifier such as monoglycerolpalmitate (MGP).
VII Fruit juice concentrate added to give flavour/fruit value, solids should be balanced if added: level shown is an example and can be any fruit
VIII Any typically used water ice food acid such as citric acid.
VIV Any typically used water ice artificial sweetener such as acesulfame or aspartame or a 50/50 blend of both.
TS indicates the total solids content as a percentage by weight.
TF indicates the total fat content (including emulsifier) as a percentage by weight.

The determination of these values is conventional in the art.

Mix Process

All dry ingredients with the exception of the acidifier mix were added to water which was pre-heated to 80° C., followed by stirring for 5 minutes. Then all the liquid ingredients and acidifier were added, stored for 1 minute, pasteurised at 82° C. for 33 seconds, homogenised at 150-170 bar pressure and cooled to 5° C. until required. Glacein was added post pasteurisation for the purposes of this study, addition pre-pasteurisation would require removal of an equal weight of water from the formulation.

Particle Formation

The liquid mix at 5° C. was loaded into a mix chamber of 5 litres capacity which fed directly into a dripping nozzle of 1 mm internal diameter. The liquid drops in turn fell into liquid nitrogen where they were rapidly frozen into approximately spherical balls. From here they were filled into a cylindrical type cup (height 95 cm, bottom outside diameter 63 cm, top outside diameter 46 mm) to a fill weight of 85 g, from the base, the base being sealed on with an iron. The products were then placed at −25° C. until required for measurement.

Free Flow Test

Samples are held at a constant temperature of either −10° C. or −25° C. for 50 days. Samples in a pot (six replicates) were squeezed manually at −25° C., the pot was then opened and upturned and the flow properties of the contents assessed on a 5 point scale according to which:
1=particles exit pot and are completely free flowing.
2=if particles do not exit at 1, pot is re-closed and inverted 5 times to separate the particles, which exit when the lid is opened and upturned.
3=as 2 but two gentle squeezes to the sides are additionally required before particles will exit. No residual deformation of the pack is seen.
4=as 3 but two harder squeezes are required which will deform the pack, leaving it still deformed after the particles are removed.
5=particles can not be made to exit.

A squeeze score of 3 is considered the maximum in terms of acceptable flowability. The scores quoted in Table 2 are mean values of the scores obtained for six replicate samples. The test was performed with respect to time, sampling every few days.

Results

TABLE 2

| | C. Ex. 1 | | Ex. 1a | | Ex. 1b | | Ex. 1c | | Ex. 1d | |
|---|---|---|---|---|---|---|---|---|---|---|
| | Squeeze | | Squeeze | | Squeeze | | Squeeze | | Squeeze | |
| Time | value | | value | | value | | value | | value | |
| (Days) | −10° C. | −25° C. | −10° C. | −25° C. | −10° C. | −25° C. | −10° C. | −25° C. | −10° C. | −25° C. |
| 1 | 2 | n.d | 2 | n.d | n.d | n.d | 3 | 2 | n.d | n.d |
| 2 | n.d | n.d | n.d | n.d | 3 | 2 | n.d | n.d | n.d | n.d |
| 3 | 4 | 2 | 3 | 2 | 3 | 2 | n.d | n.d | 3 | 2 |
| 4 | n.d | 2 | 3 | 2 | 3 | 2 | 3 | 2 | 3 | 2 |
| 5 | n.d | n.d | n.d | n.d | 3 | 2 | 3 | 2 | 3 | 2 |
| 7 | 3 | 2 | 3 | 2 | 3 | 2 | n.d | n.d | 3 | 2 |
| 10 | 4 | 2 | 4 | 3 | 3 | 2 | 3 | 3 | 3 | 2 |
| 15 | 4 | 2 | 4 | 3 | 3 | 2 | 3 | 3 | 3 | 2 |
| 21 | 5 | 3 | 3 | 3 | 3 | 2 | 3 | 3 | 3 | 2 |
| 30 | 5 | 3 | 3 | 3 | 3 | 2 | 4 | 2 | 3 | 2 |
| 40 | 5 | 3 | 3 | 3 | 4 | 2 | 3 | 2 | 3 | 2 |
| 50 | 5 | 3 | 5 | 3 | 4 | 2 | 4 | 3 | 3 | 2 |

| | C. Ex. 2 | | Ex. 2 | | C. Ex. 3 | | Ex. 3 | |
|---|---|---|---|---|---|---|---|---|
| | Squeeze | | Squeeze | | Squeeze | | Squeeze | |
| Time | value | | value | | value | | value | |
| (Days) | −10° C. | −25° C. | −10° C. | −25° C. | −10° C. | −25° C. | −10° C. | −25° C. |
| 1 | 3 | 1 | 2 | 1 | 3 | 2 | 2 | 1 |
| 2 | n.d | n.d | 2 | 1 | 3 | 2 | 2 | 1 |
| 3 | n.d | n.d | 2 | 2 | 3 | 2 | 2 | 2 |
| 4 | 5 | 2 | n.d | n.d | n.d | n.d | n.d | n.d |
| 5 | 4 | 2 | n.d | n.d | n.d | n.d | n.d | n.d |
| 7 | 4 | 2 | 3 | 2 | 3 | 3 | 3 | 2 |
| 10 | 4 | 2 | 3 | 3 | 4 | 2 | 3 | 2 |
| 15 | 4 | 2 | 3 | 2 | 4 | 3 | 3 | 2 |
| 21 | 5 | 2 | 3 | 2 | 4 | 3 | 3 | 2 |
| 30 | 5 | 3 | 3 | 2 | 4 | 3 | 3 | 2 |
| 40 | 5 | 3 | 3 | 2 | 5 | 3 | 3 | 2 |
| 50 | 5 | 3 | 3 | 2 | 5 | 3 | 3 | 3 |

| | | | |
|---|---|---|---|
| | C. Ex. 4 | Ex. 4 | Ex. 5 |
| Time | Squeeze value | Squeeze value | Squeeze value |

| (Days) | −10° C. | −25° C. | −10° C. | −25° C. | −10° C. | −25° C. |
|---|---|---|---|---|---|---|
| 1 | 3 | 1 | 3 | 1 | 3 | 2 |
| 2 | 3 | 2 | 2 | 1 | n.d | n.d |
| 3 | n.d | n.d | 3 | 1 | n.d | n.d |
| 4 | n.d | n.d | n.d | n.d | 2 | 2 |
| 5 | 3 | 2 | n.d | n.d | n.d | n.d |
| 7 | 3 | 2 | 3 | 1 | n.d | n.d |
| 10 | 3 | 1 | 2 | 1 | n.d | n.d |
| 15 | 3 | 2 | 3 | 2 | 3 | 2 |
| 21 | 3 | 2 | 3 | 2 | 3 | 2 |
| 30 | 3 | 3 | 3 | 2 | 3 | 2 |
| 40 | 4 | 3 | 3 | 3 | 3 | 2 |
| 50 | 4 | 3 | 3 | 3 | 3 | 2 |
| 90 | n.d | n.d | n.d | n.d | 4 | 2 |

All publications mentioned in the above specification are herein incorporated by reference. Various modifications and variations of the described methods and products of the invention will be apparent to those skilled in the art without departing from the scope of the invention. Although the invention has been described in connection with specific preferred embodiments, it should be understood that the invention as claimed should not be unduly limited to such specific embodiments. Indeed, various modifications of the described modes for carrying out the invention which are apparent to those skilled in the relevant fields are intended to be within the scope of the following claims.

1. A frozen confectionery product comprising a plurality of discrete water ice confections, each discrete water ice confection being able to contact directly other discrete water ice confections in the product, which water ice confections comprise an ice structuring protein (ISP), at least 6 wt % solids and have an average volume of less than 1 ml.

2. A product according to claim 1 which comprises at least 10 discrete water ice confections.

3. A product according to claim 1 which comprises at least 100 discrete water ice confections.

4. A product according claim 1 wherein the discrete water ice confections have an average volume of less than 0.5 ml.

5. A product according to claim 1 which is an unaerated water ice.

6. A product according to claim 1 wherein the discrete water ice confections comprise at least about 10 wt % solids.

7. A product according to claim 1 wherein the ISP is a fish type III ISP.

8. A product according to claim 7 wherein the ISP is type III AFP HPLC-12.

9. A product according to claim 1 wherein the frozen confections comprise at least 0.0005 wt % of the ISP.

10. A product comprising a container filled with a frozen confectionery product according to claim 1.

11. A product according to claim 10 wherein the container has a volume of from 100 ml to 1000 ml.

12. A retail unit comprising a plurality of containers, each container comprising a product according to claim 1 wherein the product in each container is different.
